(19) United States
(12) Patent Application Publication
(10) Pub. No.: US 2025/0306304 A1
(43) Pub. Date: Oct. 2, 2025

(54) FIBER ARRAY UNIT FOR HIGH DENSITY OPTICAL FIBER CONNECTIONS TO PHOTONIC INTEGRATED CIRCUIT SHORELINES

(71) Applicant: Intel Corporation, Santa Clara, CA (US)

(72) Inventors: Feifei Cheng, Chandler, AZ (US); Ziyin Lin, Chandler, AZ (US); Yang Wu, Chandler, AZ (US); Fan Fan, Chandler, AZ (US); Jianyong Mo, Chandler, AZ (US); Peter Williams, Phoenix, AZ (US); Darren Vance, Gilbert, AZ (US); Saikumar Jayaraman, Chandler, AZ (US); Kumar Abhishek Singh, Phoenix, AZ (US)

(73) Assignee: Intel Corporation, Santa Clara, CA (US)

(21) Appl. No.: 18/620,911

(22) Filed: Mar. 28, 2024

(51) Int. Cl. G02B 6/42

(52) U.S. Cl. CPC G02B 6/423

(57) ABSTRACT

An optical fiber housing comprises a first face, a second face opposite the first face, a first side, and a second side opposite the first side. The first face is spaced apart from the second face by a first distance. A plurality of optical fibers extends in a longitudinal direction between the first and second faces, and are laterally spaced apart across a transverse width of the first face between the first side and the second side. Each optical fiber comprises a diameter. A surface of the housing is orthogonal to the first face and the first side. A plurality of alignment features is on the surface stand off from a remainder of the surface by a height greater than the diameter. The alignment features extend a second distance in the longitudinal direction that is less than the first distance, and comprises a curved or V-shaped peripheral surface.

### GOVERNMENT INTEREST STATEMENT

This invention was made with government support under Agreement No. N00164-19-9-0001, awarded by NSWC Crane Division. The government has certain rights in the invention.

### BACKGROUND

In electronics manufacturing, integrated circuit (IC) packaging is a stage of semiconductor device fabrication in which an IC that has been monolithically fabricated on a chip (or die) is assembled into a “package” that can protect the IC chip from physical damage. The package can also communicatively connect the IC chip to other packaged IC chips and/or a scaled host component, such as a package substrate, or a printed circuit board. Multiple IC chips can be co-assembled, for example, into a multi-die package (MCP).

A photonic integrated circuit (PIC) includes integrated photonic devices or elements. Silicon PICs (SiPh) have one or more silicon photonic waveguides that convey light within the PIC. These silicon waveguides can terminate at end surfaces suitable for coupling with optical fibers. The waveguide end surfaces may be located on the shoreline (or the peripheral edge) of the PIC. Optical fibers can be coupled with the waveguides at their end surfaces on the shoreline. Lens or spot size converters may be used at the interface to facilitate alignment of the optical fibers with the waveguides. A fiber array unit (FAU) or waveguide housing may be used to retain optical fibers in a positional relationship with a PIC.

Optical fibers may be coupled with a PIC using passive or active alignment techniques. Active alignment techniques are more time consuming than passive alignment techniques. With passive alignment techniques, it can be challenging to precisely align all fibers with waveguide end surfaces. When a FAU holds a relatively large number of optical fibers, the challenge of precisely aligning all fibers with waveguide end surfaces becomes even more difficult.

The need to transfer large amounts of data in and out of PICs at high rates is ever increasing. As a result, it would be desirable to increase the number of optical fibers that can be coupled to the shoreline of a PIC using passive alignment techniques.

### BRIEF DESCRIPTION OF THE DRAWINGS

The subject matter described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Views referred to as “cross-sectional”, “profile” and “plan” correspond to orthogonal planes within a cartesian coordinate system. Thus, cross-sectional and profile views are taken in the x-z plane, and plan views are taken in the x-y plane. Typically, profile views in the x-z plane are cross-sectional views. Where appropriate, drawings are labeled with axes to indicate the orientation of the figure. Further, where considered appropriate, reference labels have been repeated among the figures to indicate corresponding or analogous elements. In the figures:

FIGS. 1A-1D illustrate isometric views of an optical fiber housing, according to various embodiments;

FIG. 1E illustrates an exploded view of a system comprising an optical fiber housing and a photonic integrated circuit (PIC) die for interfacing with the optical fiber housing, according to some embodiments;

FIGS. 2A-2B illustrate side views of the optical fiber housing depicted in FIG. 1A and FIG. 1B, in accordance with some embodiments;

FIGS. 3A-3B illustrate side views of the optical fiber housing depicted in FIG. 1B, in accordance with some embodiments;

FIGS. 4A-4C illustrate side views of an optical fiber housing with alignment features on a surface, and FIG. 4D illustrates an isometric view of a PIC die for interfacing with the optical fiber housing of FIGS. 4A-4C, in accordance with some embodiments;

FIG. 5A illustrates a side view of an optical fiber housing with alignment features on a surface, FIG. 5B illustrates an isometric view of the optical fiber housing of FIG. 5A, and FIG. 5C is a longitudinal cross-sectional view of a system that includes the optical fiber housing of FIGS. 5A-5B interfacing with a PIC die, in accordance with some embodiments;

FIG. 6A and FIG. 6C illustrate side views of an optical fiber housing with alignment features on a surface, FIG. 6B illustrates an isometric view of the optical fiber housing of FIG. 6A and FIG. 6C, and FIG. 6C is a longitudinal cross-sectional view of a system that includes the optical fiber housing of FIG. 6A and FIG. 6B interfacing with a PIC die, in accordance with some embodiments;

FIG. 7A is an isometric view of a PIC die, FIG. 7B and FIG. 7C illustrate side views of an optical fiber housing for interfacing with the PIC die of FIG. 7A, FIG. 7D illustrates isometric views of alternative alignment features that may be provided on a surface of the optical fiber housing of FIG. 7B and FIG. 7C, and FIG. 7E is an isometric view of the optical fiber housing of FIG. 7B and FIG. 7C, in accordance with some embodiments;

FIG. 8A and FIG. 8B are isometric views of an optical fiber housing 806, FIGS. 8C-8F illustrate side views of the optical fiber housing of FIG. 8A and FIG. 8B, and FIG. 8G is a longitudinal cross-sectional view of a system that includes the optical fiber housing of FIG. 8A and FIG. 8B interfacing with a PIC die via alignment features comprising solder, in accordance with some embodiments;

FIG. 9 illustrates a mobile computing platform and a data server machine employing one or more apparatus comprising an optical feature at an end face of an optical fiber coupled with an optical feature on a surface of a PIC die, in accordance with some embodiments; and

FIG. 10 is a functional block diagram of an electronic computing device, in accordance with some embodiments.

### DETAILED DESCRIPTION

Embodiments are described with reference to the enclosed figures. While specific configurations and arrangements are depicted and discussed in detail, this is done for illustrative purposes only. Persons skilled in the relevant art will recognize that other configurations and arrangements are possible without departing from the spirit and scope of the description. It will be apparent to those skilled in the relevant art that techniques and/or arrangements described herein may be employed in a variety of other systems and applications other than what is described in detail herein.

Reference is made in the following detailed description to the accompanying drawings, which form a part hereof and illustrate exemplary embodiments. Further, it is to be understood that other embodiments may be utilized and structural and/or logical changes may be made without departing from the scope of claimed subject matter. It should also be noted that directions and references, for example, up, down, top, bottom, and so on, may be used merely to facilitate the description of features in the drawings. Therefore, the following detailed description is not to be taken in a limiting sense and the scope of claimed subject matter is defined solely by the appended claims and their equivalents.

In the following description, numerous details are set forth. However, it will be apparent to one skilled in the art, that embodiments may be practiced without these specific details. In some instances, well-known methods and devices are shown in block diagram form, rather than in detail, to avoid obscuring the embodiments. Reference throughout this specification to “an embodiment” or “one embodiment” or “some embodiments” means that a particular feature, structure, function, or characteristic described in connection with the embodiment is included in at least one embodiment. Thus, the appearances of the phrase “in an embodiment” or “in one embodiment” or “some embodiments” in various places throughout this specification are not necessarily referring to the same embodiment. Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

As used in the description and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items.

The terms “coupled” and “connected,” along with their derivatives, may be used herein to describe functional or structural relationships between components. These terms are not intended as synonyms for each other. Rather, in particular embodiments, “connected” may be used to indicate that two or more elements are in direct physical, optical, or electrical contact with each other. “Coupled” may be used to indicated that two or more elements are in either direct or indirect (with other intervening elements between them) physical or electrical contact with each other, and/or that the two or more elements co-operate or interact with each other (e.g., as in a cause-and-effect relationship).

The terms “over,” “under,” “between,” and “on” as used herein refer to a relative position of one component or material with respect to other components or materials where such physical relationships are noteworthy. For example, in the context of materials, one material or layer over or under another may be directly in contact or may have one or more intervening materials or layers. Moreover, one material between two materials or layers may be directly in contact with the two materials/layers or may have one or more intervening materials/layers. In contrast, a first material or layer “on” a second material or layer is in direct physical contact with that second material/layer. Similar distinctions are to be made in the context of component assemblies.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C.

Unless otherwise specified in the specific context of use, the term “predominantly” means more than 50%, or more than half. For example, a composition that is predominantly a first constituent means more than half of the composition is the first constituent (e.g., <50 at. %). The term “primarily” means the most, or greatest, part. For example, a composition that is primarily a first constituent means the composition has more of the first constituent than any other constituent. A composition that is primarily first and second constituents means the composition has more of the first and second constituents than any other constituent. The term “substantially” means there is only incidental variation. For example, composition that is substantially a first constituent means the composition may further include <1% of any other constituent. A composition that is substantially first and second constituents means the composition may further include <1% of any constituent substituted for either the first or second constituent.

Optical fibers in a fiber array unit (FAU) may be passively aligned with a photonic integrated circuit (PIC) die by providing V-grooves on a surface of the PIC die. In passive alignment techniques, tips of the fiber are placed in the V-grooves. However, when a FAU holds a relatively large number of optical fibers, it becomes difficult to precisely align all of the fibers with waveguide end surfaces on the PIC. In addition, V-grooves in the PIC may reduce the mechanical strength and structural integrity of the PIC.

Embodiments described herein provide high optical fiber shoreline density without-grooves on a surface of the PIC die. Embodiments advantageously include passive alignment mechanisms located outside of the light coupling region between the optical fibers and end surfaces of PIC waveguides. Further advantages are that embodiments may allow pitch between optical fibers to be decreased and the number of optical fibers coupled to the shoreline of a PIC die to be increased, as compared to know methods. In addition, embodiments may advantageously reduce defects associated with processes for forming V-grooves on a surface of a PIC die. Another advantage of embodiments is that the mechanical strength and structural integrity of the PIC die may be increased relative to know methods.

Embodiments are directed to a high fiber count FAU with tight fiber position tolerance. Embodiments of the FAU may alternatively be referred to herein as an “optical fiber housing.” To achieve tight positional tolerance of optical fiber tips, embodiments of a FAU secure an array of optical fibers to the unit and may precisely align the position of the array within 1 μm tolerance. First, alternative embodiments for retaining optical fibers within an FAU are described. Second, an example of a PIC die that may be used with an optical fiber housing employing one of the alternative embodiments for retaining optical fibers is described. After alternative FAUs and the PIC die are described, various passive alignment features that may be used with any the alternative optical fiber housings are described.

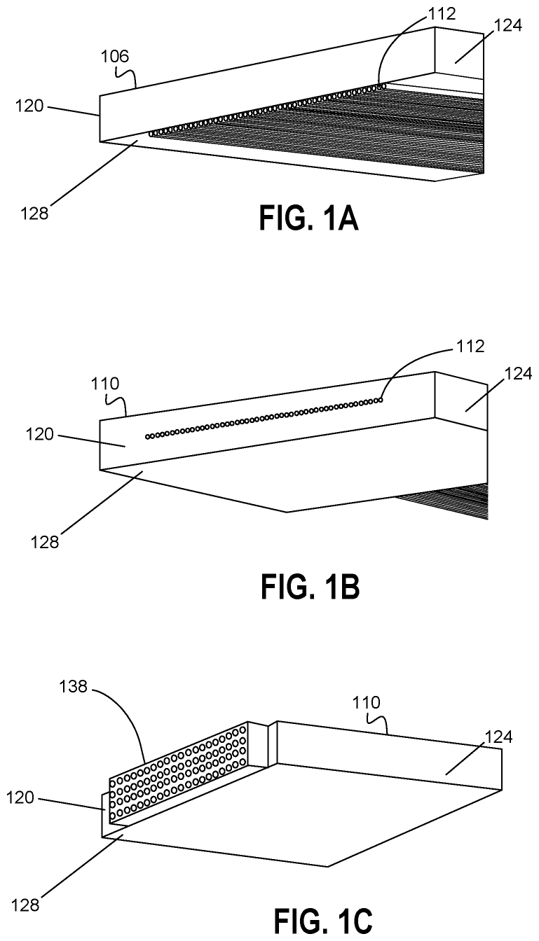

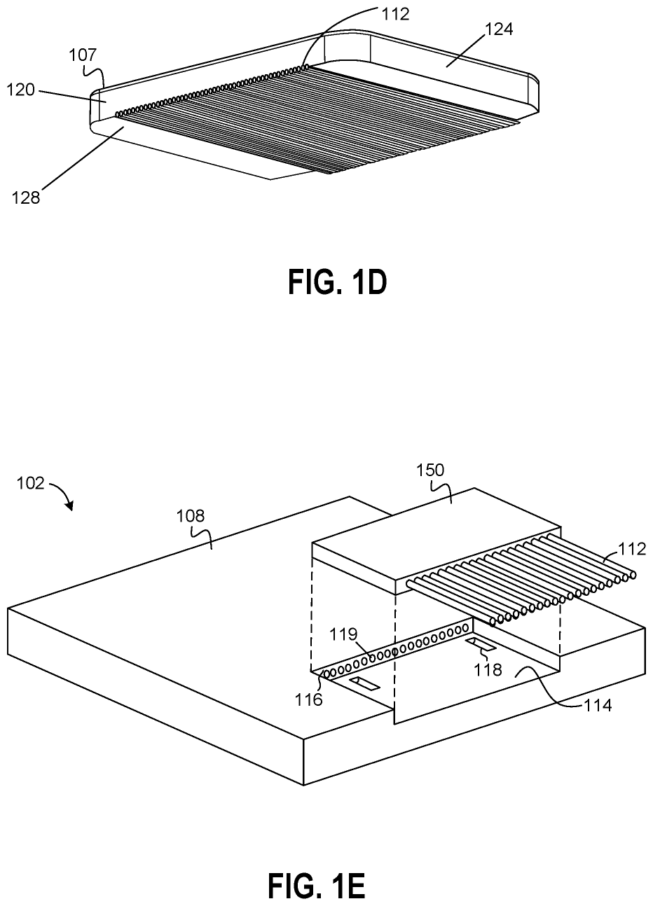

FIGS. 1A-1D are isometric views of an optical fiber housing, in accordance with some embodiments. FIG. 1A illustrates an optical fiber housing 106 with grooves on a surface and a high fiber count array of optical fibers 112 aligned with the grooves, according to some embodiments. FIG. 1B illustrates an alternative optical fiber housing 110 with holes through the housing and a plurality of optical fibers 112 within the holes, according to some embodiments. FIG. 1C illustrates optical fiber housing 110 of FIG. 1B with a micro-lens array 138 attached to a front surface of the housing, according to some embodiments. FIG. 1D illustrates a stamped metal optical fiber housing 107 with grooves on a surface and a high fiber count array of optical fibers 112 aligned with the grooves, according to some embodiments. FIG. 1E illustrates an exploded view of a system comprising an optical fiber housing and a photonic integrated circuit (PIC) die for interfacing with the optical fiber housing, according to some embodiments. The optical fiber housings 106, 107, and 110 illustrated in FIGS. 1A-1D include a face 120, a surface 128, and a side 124.

Known metal stamping technology capable of forming features with micron level accuracy may be used to fabricate V-groove features metal optical fiber housing 107 illustrated in FIG. 1D. Optical fiber housing 107 may be any suitable metal or metal alloy, such as Kovar or Invar. Metal optical fiber housing 107 may provide advantages as compared with FAU embodiments comprising polymer or glass, such as high temperature compatibility, higher fracture strength, and improved structure integrity. The front face of metal optical fiber housing 107 may be polished to provide a tight profile/flatness tolerance and optical fiber with tight facet angle tolerance to interface with a spot size converter (SSC) or edge inverse taper (EIT) waveguides on the PIC die coupling interface.

In addition to metal, an optical fiber housing may comprise glass, polymers, or silicon in various embodiments. For example, an optical fiber housing may be high-precision machined/fused glass. In another example, an optical fiber housing may be high-precision molded polymer. In a further example, an optical fiber housing may be silicon fabricated utilizing known wafer fabrication technology. Some wafer fabrication is capable of tight tolerances, such that 60-127 μm pitch V- or U-grooves may be formed on a surface of an optical fiber housing. Groove pitches in this range would enable optical fiber with a cladding diameter 50 μm-125 μm to be placed within the grooves. Known optical fiber pitches may be in the 250 μm range. Accordingly, an advantage of some embodiments may be an increase of optical fiber shoreline density of 2 to 5 times that of known shoreline density.

Embodiments are directed to an optical fiber housing suitable for high density optical fiber connections with a PIC die. In embodiments, the optical fiber housings embodiments may hold any number, and preferably a relatively large number, of optical fibers, e.g., 4, 8, 16, 32, 48, 64 optical fibers, etc. While some illustrations of optical fiber housings shown herein may retain a relatively large number of optical fibers, e.g., 48, other illustrations show optical fiber housings that retain only a relatively small number of optical fibers. This is for clarity of illustration only. It should be understood that any of the illustrations herein of example optical fiber housings that are shown as only retaining less than a relatively large number of fibers may, in some embodiments, retain a relatively large number of optical fibers.

FIG. 1E illustrates an exploded view of a system 102 comprising an optical fiber housing and a photonic integrated circuit (PIC) die for interfacing with the optical fiber housing, according to some embodiments. PIC die 108 includes a surface 114 and a surface 116, in accordance with some embodiments. The surface 114 includes a plurality alignment features 118. Alignment features 118 may be recessed into or on surface 114 in various embodiments. Surface 116 of PIC die 108 is substantially orthogonal to surface 114 and includes a plurality of optical waveguide ends 119.

Optical fiber housing 150 retains a plurality of optical fibers 112 and includes a surface that faces surface 114, e.g. a bottom surface in FIG. 1E. Alignment features 118 may be complimentary to alignment features on the surface of optical fiber housing 150 that faces surface 114. While optical fiber housing 150 is shown as retaining a relatively small number of optical fibers 112, in some embodiments, optical fiber housing 150 retains a relatively large number of optical fibers 112, e.g., 48.

PIC die 108 may include circuitry to receive optical signals from a source, e.g., optical fiber housing 106, and convert optical signals to electrical signals. Similarly, PIC die 108 may include circuitry to receive electrical signals and generate optical signals based on electrical signals. PIC die 108 may include optical components such as lasers or other light sources, detectors, waveguides, and other optical elements, e.g., couplers or filters. PIC die 108 may include one or more planar silicon photonic waveguides, which convey light within the PIC die. PIC die 108 may include electrical components, such as active components, e.g., transistors, and passive components, e.g., conductive vias and lines. In embodiments, PIC die 108 comprises a plurality of outer surfaces and one or more waveguides within the PIC die 108 that terminate at or on one or more of the surfaces, e.g., surface 116 of PIC die 108. PIC die 108 may be attached to a package substrate (not shown in FIG. 1E).

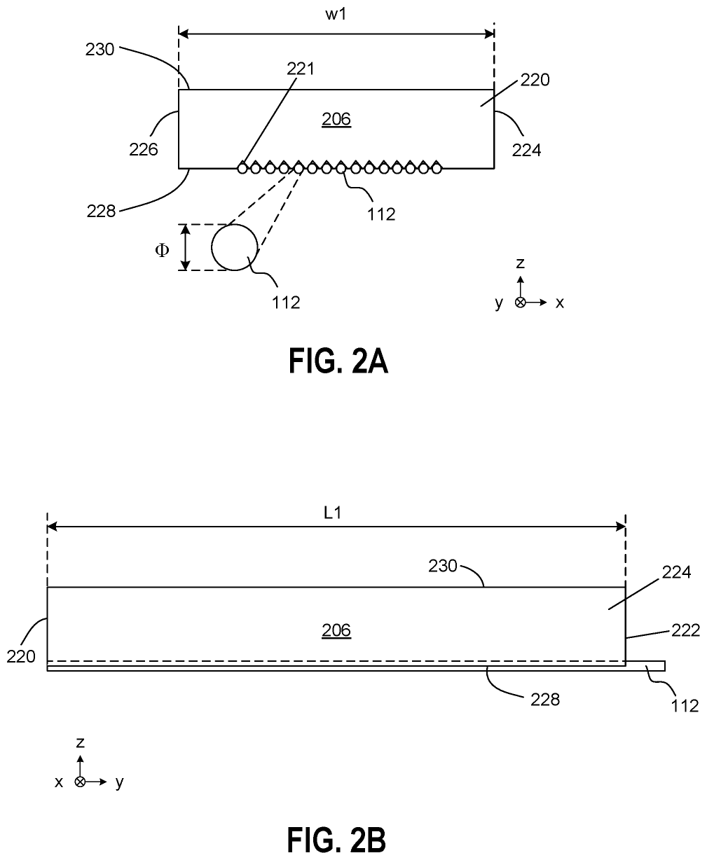

FIGS. 2A-2B illustrate side views of an optical fiber housing 206, in accordance with some embodiments. Optical fiber housing 206 may be substantially the same as optical fiber housing 106 depicted in FIG. 1A, differing only in the number of optical fibers being retained in the housing. While optical fiber housing 206 is shown as retaining a relatively small of number optical fibers 112, in some embodiments, optical fiber housing 206 retains a relatively large number of optical fibers 112, e.g., 48.

Optical fiber housing 206 includes a first face 220 and a second face 222, which is opposite the first face 220. The first face 220 may be spaced apart from the second face 222 by a first distance L1. Optical fiber housing 206 also includes a first side 224, and a second side 226. First side 224 is opposite second side 226. First side 224 and second side 226 are spaced apart by a transverse width w1 (in the x direction). Optical fiber housing 206 includes a surface 228, which is a bottom surface in FIGS. 2A-2B. Surface 228 is orthogonal to the first face 220 and the first side 224. In addition, surface 228 is opposite surface 230, which is a top surface in FIGS. 2A-2B.

Surface 228 includes a plurality of grooves 221 extending in the longitudinal direction between the first face 220 and the second face 222. The grooves 221 may be V-shaped or U-shaped. A plurality of optical fibers 112 extend in a longitudinal direction (in the y direction) between the first face 220 and the second face 222. The plurality of optical fibers 112 are laterally spaced apart across a transverse width w1 of the first face 220 between the first side 224 and the second side 226. Each optical fiber 112 comprises a diameter @. Each of the plurality of optical fibers 112 may be substantially parallel to surface 228. The plurality of optical fibers 112 are retained in the plurality of grooves 221 on surface 228. The optical fibers 112 may be secured in the grooves with a low CTE (coefficient of temperature expansion) epoxy adhesive. In some embodiments, the optical fibers 112 are within an array. The optical fibers 112 may be closely packed together. The cladding diameter may be used for further position control, as cladding diameter tolerance may be less than 1 μm.

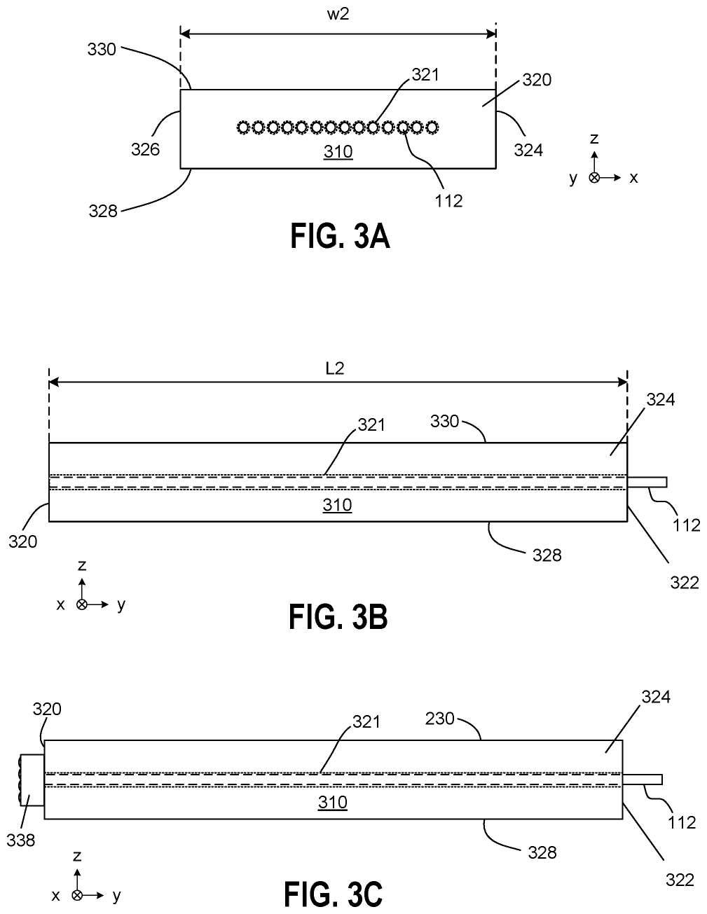

FIGS. 3A-3B illustrate side views of optical fiber housing 310, in accordance with some embodiments. FIG. 3C illustrates a side view of optical fiber housing 310 with the micro-lens array 338, which may be substantially the same as micro-lens array 138, depicted in FIG. 1C, in accordance with some embodiments. Optical fiber housing 310 may be substantially the same as optical fiber housing 110 depicted in FIGS. 3A-3B, differing only in the number of optical fibers being retained in the housing. While optical fiber housing 310 is shown as retaining a relatively small number of optical fibers 112, in some embodiments, optical fiber housing 310 retains a relatively large number of optical fibers 112, e.g., 48.

Optical fiber housing 310 includes a first face 320 and a second face 322, which is opposite the first face 320. The first face 320 may be spaced apart from the second face 322 by a distance L2. Optical fiber housing 310 also includes a first side 324, and a second side 326. First side 324 is opposite second side 326. First side 324 and second side 326 are spaced apart by a transverse width w2 (in the x direction). Optical fiber housing 310 includes a surface 328, which is a bottom surface in FIGS. 3A-3C. Surface 328 is orthogonal to the first face 320 and the first side 324. In addition, surface 328 is opposite surface 330, which is a top surface in FIGS. 3A-3C.

Optical fiber housing 310 includes a plurality of holes 321 extending in the longitudinal direction between the first face 320 and the second face 322. A plurality of optical fibers 112 extend in a longitudinal direction (in the y direction) between the first face 320 and the second face 322. The plurality of optical fibers 112 are laterally spaced apart across transverse width w2 of the first face 320 between the first side 324 and the second side 326. Each optical fiber 112 comprises a diameter @. The plurality of optical fibers 112 are retained in the holes 321. Each of the plurality of optical fibers 112 may be substantially parallel to surface 328. The optical fibers 112 may be secured in the holes 321 with a low CTE epoxy adhesive. In examples in which the optical fiber housing 310 comprises silicon or polymer materials, the holes 321 may be made using laser drilling or laser-assisted high precision etching. In examples in which the optical fiber housing 310 comprises glass, the alignment features may be made by high-precision glass molding process.

Referring to FIG. 3C, the micro-lens array 138 is on or proximate to first face 320 of optical fiber housing 110. Micro-lens array 138 may include a plurality of optical elements. Individual optical elements of micro-lens array 138 may be coupled with individual optical fibers 112. A PIC die (not shown) includes a plurality of optical waveguides with optical elements at ends of the waveguides. The optical elements of micro-lens array 138 may be aligned with the corresponding optical elements of the PIC die. The optical elements of micro-lens array 138 and corresponding optical elements of the PIC die may be used to implement a beam expansion technique for coupling light between optical fibers 112 and PIC die waveguides.

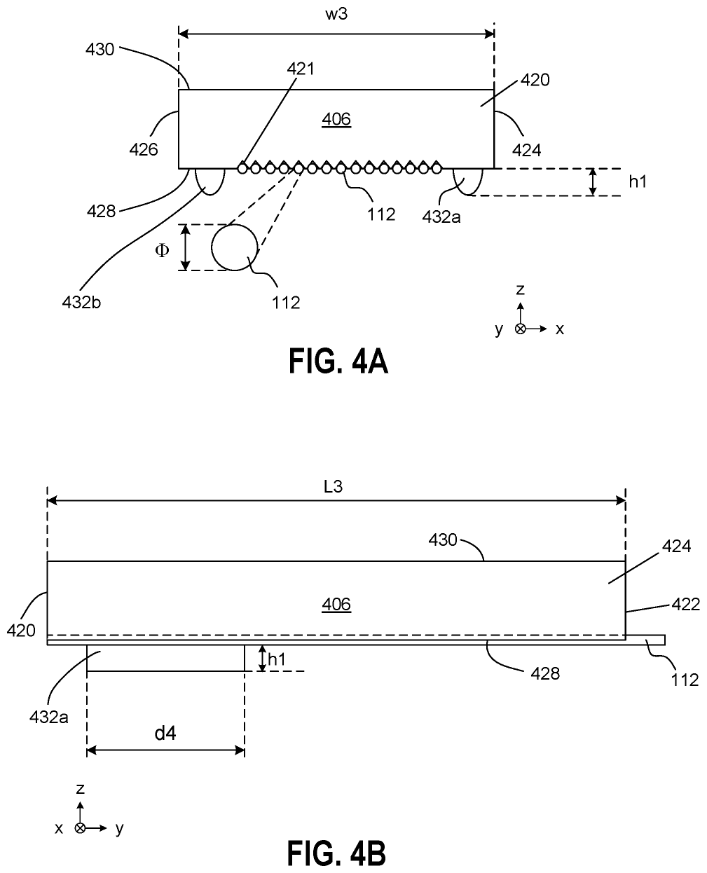

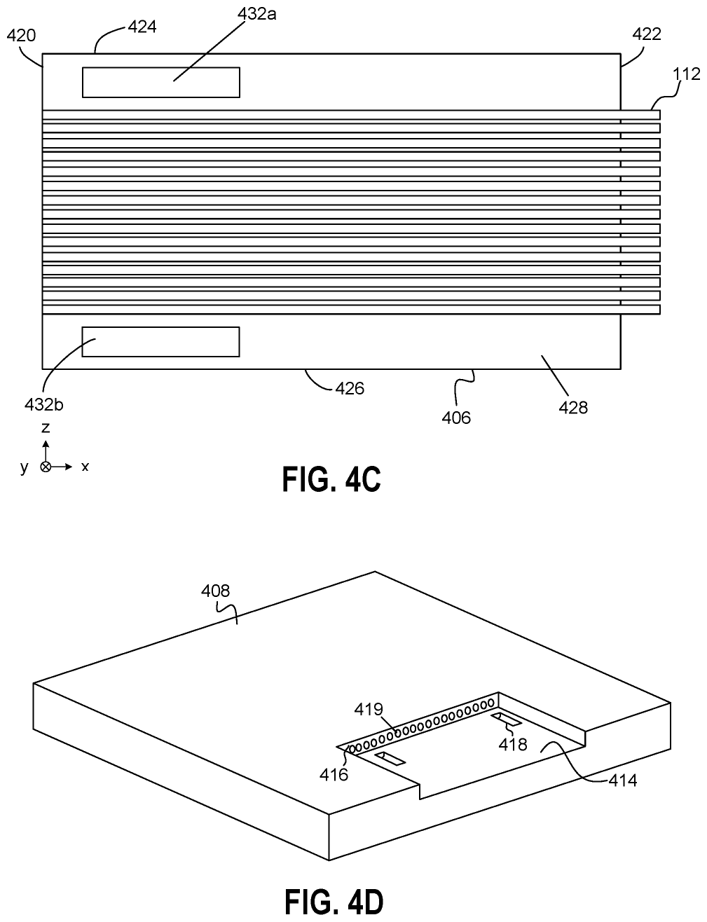

FIGS. 4A-4C illustrate side views of optical fiber housing 406, in accordance with some embodiments. FIG. 4D is an isometric view of a photonic integrated circuit (PIC) die 408, in accordance with some embodiments. Referring to FIGS. 4A-4C, optical fiber housing 406 includes a first face 420 and a second face 422, which is opposite the first face 420. The first face 420 may be spaced apart from the second face 422 by a first distance L3. Optical fiber housing 406 also includes a first side 424, and a second side 426. First side 424 is opposite second side 426. First side 424 and second side 426 are spaced apart by a transverse width w3 (in the x direction). Optical fiber housing 406 includes a surface 428, which is a bottom surface in FIGS. 4A-4C. Surface 428 is orthogonal to the first face 420 and the first side 424. In addition, surface 428 is opposite surface 430, which is a top surface in FIGS. 4A-4C.

Surface 428 includes a plurality of grooves 421 extending in the longitudinal direction between the first face 420 and the second face 422. The grooves 421 may be V-shaped or U-shaped. A plurality of optical fibers 112 extend in a longitudinal direction (in the y direction) between the first face 420 and the second face 422. The plurality of optical fibers 112 are laterally spaced apart across a transverse width w1 of the first face 420 between the first side 424 and the second side 426. Each optical fiber 112 comprises a diameter @. The plurality of optical fibers 112 are retained in the plurality of grooves 421 on surface 428. While optical fiber housing 406 is shown as retaining a relatively small number of optical fibers 112, in some embodiments, optical fiber housing 406 retains a relatively large number of optical fibers 112, e.g., 48. The optical fibers 112 may be secured in the grooves with a low CTE (coefficient of temperature expansion) epoxy adhesive. In some embodiments, high density optical fibers within an array can be close packed together using cladding diameter for further position control, as cladding diameter tolerance may be less than 1 μm. In some embodiments, optical fiber housing 406 may retain fibers in substantially the same way as optical fiber housing 310 depicted in FIGS. 3A-3C, differing only in the number of optical fibers being retained in the housing, i.e., the plurality of optical fibers 112 are between the first surface and the second surface.

In some embodiments, surface 428 of optical fiber housing 406 includes a plurality of alignment features 432. In the example shown in FIGS. 4A-4C, alignment feature 432a and alignment feature 432b are on surface 428. In some embodiments, the first alignment feature 432a is proximate the first side 424 and the second alignment feature 432b is proximate the second side 426. The plurality of optical fibers 112 is between the first alignment feature 432a and the second alignment feature 432b. Each of the alignment features 432 may have a U- or V-shaped peripheral surface. Alignment features 432 may have a surface that is linear, curvilinear, or partially linear and partially curvilinear. Each of the alignment features 432a, 432b extend a second distance d4 in the longitudinal direction. The second distance d4 is less than the first distance L3, i.e., less than the distance between the first face 420 and second face 422. Each of the alignment features 432 stands off from a remainder of the surface 428 by a height h1. The height h1 of the alignment features 432 is greater than the diameter of the optical fibers 112.

FIG. 4D is an isometric view of a photonic integrated circuit (PIC) die 408 that includes a surface 414 and a surface 416. The surface 414 includes a plurality alignment features 418. Alignment features 418 may be recessed into surface 414. Surface 416 is substantially orthogonal to surface 414 and includes a plurality of optical waveguide ends 419. Alignment features 418 on surface 414 of PIC die 408 are complimentary with alignment features 432a and 432b on surface 428 of optical fiber housing 406. Alignment features 418 may interface with alignment features 432.

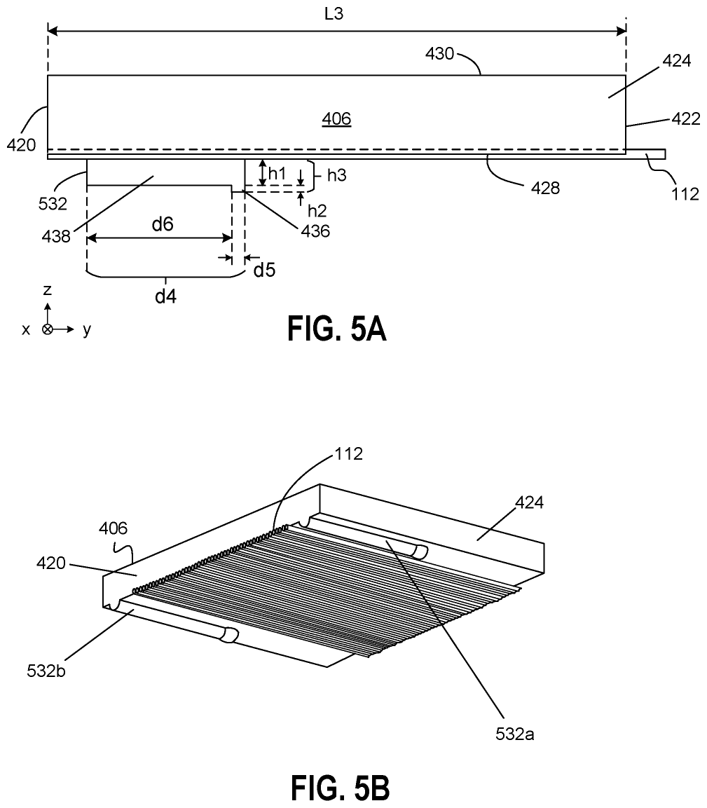

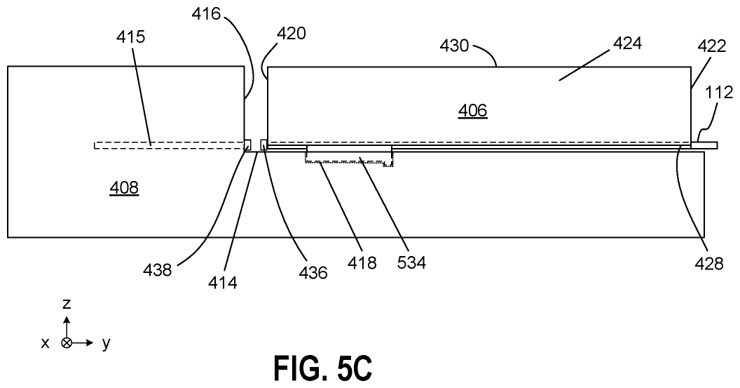

FIGS. 5A-5C illustrate views of alternative alignment features 532 that may be provided on optical fiber housing 406 in some embodiments. Alignment features 532 are similar to alignment features 432, but additionally includes a locking or keying component. The distance between the tips of optical fibers and waveguide ends on the PIC die may be controlled with precision with alignment features that incorporate a locking or keying component. The locking or keying component can serve to lock a FAU in position in the in-plane (y-axis) direction.

FIG. 5A is a side view optical fiber housing 406 and an alignment feature 532, in accordance with some embodiments. FIG. 5B is an isometric view of an optical fiber housing 406 and alignment features 532a, 532b, in accordance with some embodiments. Alignment features 532 include a locking or keying component 436. Similar to alignment features 432, alignment features 532 may be on surface 428, proximate to a side 424, and extend distance d4 in the longitudinal direction. Alignment features 532 include a first longitudinal (y-axis) section and a second longitudinal section 438. The first longitudinal section extends a distance d5 and second longitudinal section 438 extends a distance d6. The sum of distances d5 and d6 is d4, the overall length of alignment features 532. The distance d4 of alignment features 532 is less than distance L3, i.e., less than the distance between the first face 420 and second face 422. Keying component 436 may be in the first longitudinal section of alignment features 532. In some embodiments, keying component 436 may be at or proximate to an end of alignment feature 532. The second longitudinal sections 438 of alignment features 532 stand off from a remainder of the surface 428 by a height h1. Alignment features 532 stand off from a remainder of the surface 428 by a height h3, and stand off from the second longitudinal sections 438 by a height h2. The height h3 is a sum of heights h1 and h2.

FIG. 5C is a longitudinal cross-sectional view of a system that includes optical fiber housing 406 and PIC die 408 illustrating an alignment feature 436 on the optical fiber housing interfacing with complementary alignment features 418 on the PIC die, in accordance with some embodiments. FIG. 5C further illustrates an alignment feature 436 on surface 428 of optical fiber housing 406 and a complimentary alignment feature 418 on surface 414 of PIC die 408. Surface 428 is substantially parallel to and faces surface 414. Surface 428 may contact surface 414 in some examples. In other examples, surface 428 may be spaced away from surface 414. The portion of optical fibers 112 within grooves on surface 428 of optical fiber housing 406 are depicted with dashed lines, while portions of optical fibers 112 between surface 428 and surface 414 are depicted with solid lines. Alignment feature 534 is depicted with a solid line between surface 428 and surface 414, and with a dashed line below surface 414. Complimentary alignment feature 118 is depicted with a dotted line below surface 414. In embodiments, various surfaces of the alignment feature 534 make contact over at least some portion of surfaces of complimentary alignment feature 418. In some embodiments, two or more surfaces of alignment feature 534 contact facing surfaces of complimentary alignment feature 418. While alignment feature 534 is illustrated in the example of FIG. 5C, it should be appreciated that any other alignment feature on surface 428 described herein may be substituted alignment feature 534 in various embodiments.

FIG. 5C also illustrates optical elements that may be used to implement a beam expansion technique for coupling light between optical fibers 112 and PIC die waveguides. As illustrated in FIG. 5C, PIC die 108 comprises a plurality of waveguides 415 within the die, which terminate at or on surface 416. The first face 420 of optical fiber housing 406 is substantially parallel to and faces surface 416. In some embodiments, a plurality of first optical elements 436 are at or on first face 420. Each first optical element 436 may be coupled with one or more of the plurality of optical fibers 112. A plurality of second optical elements 438 are at or on surface 416. Each second optical element 438 may be coupled with one or more of the plurality of waveguides 415. In some examples, the first optical elements 436 and second optical elements 438 may be a lens or an array of lenses.

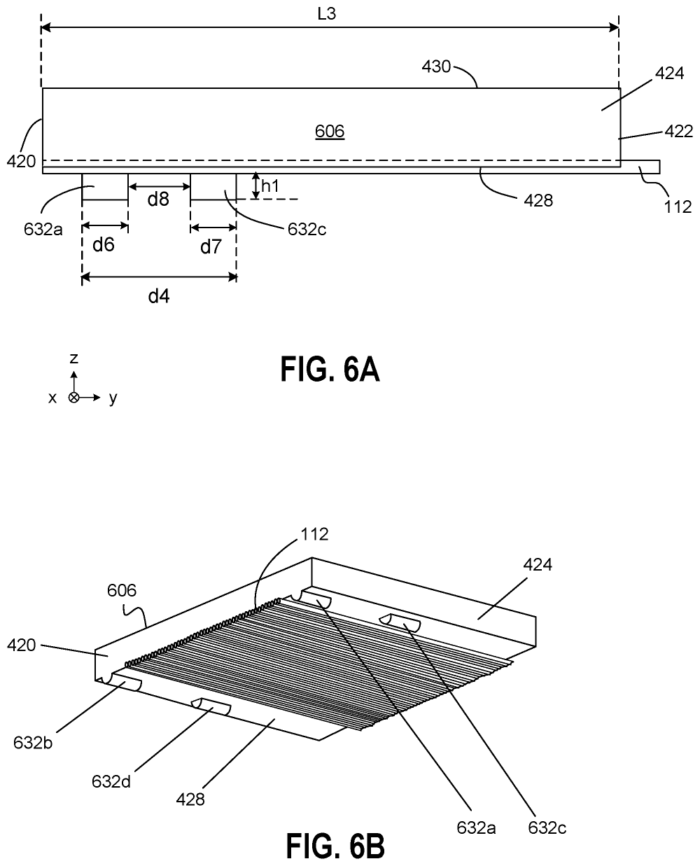

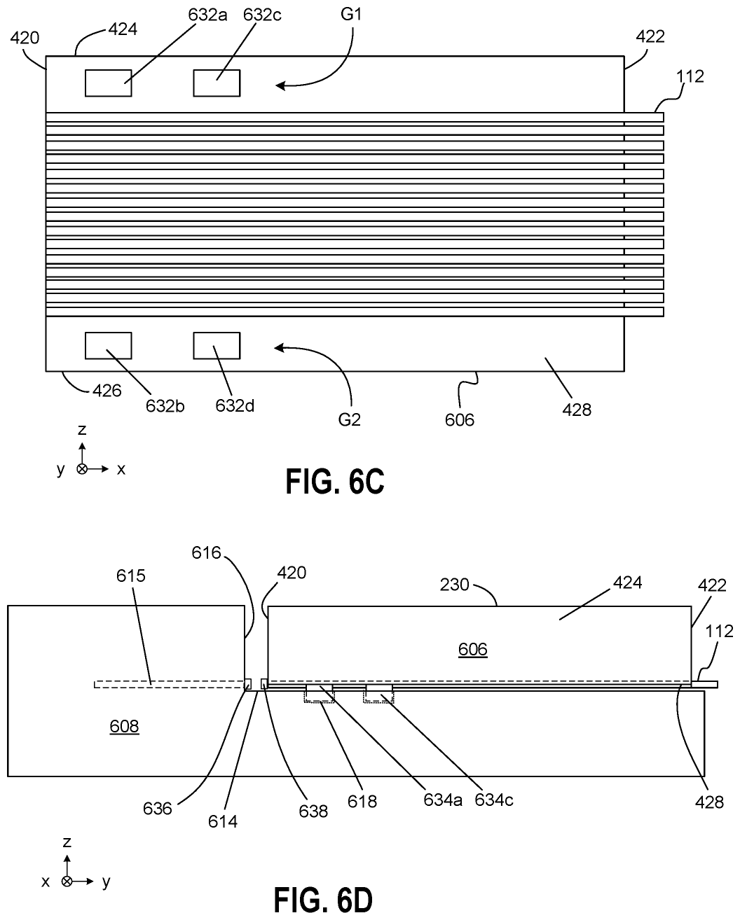

FIGS. 6A-6D illustrate alternative alignment features 632 that may be provided on optical fiber housing 406 in some embodiments. Alignment features 632 are similar to alignment features 432, but comprise segments. Segmented alignment features may be used as a locking feature to constrain in-plane relative movement. Segmented alignment features may also be used as a mechanical keying component to match FAU with a corresponding PIC die.

FIG. 6A and FIG. 6C illustrate side views of optical fiber housing 606 and alignment features 632a, 632c on a surface, in accordance with some embodiments. FIG. 6B is an isometric view of an optical fiber housing 606 and alignment features 632a, 632b, 632c, and 632d, in accordance with some embodiments. FIG. 6D is a longitudinal cross-sectional view of a system that includes optical fiber housing 606 and PIC die 608, in accordance with some embodiments. While optical fiber housing 606 is shown in FIG. 6C as retaining a relatively small number of optical fibers 112, in some embodiments, optical fiber housing 606 retains a relatively large number of optical fibers 112, e.g., 48.

Alignment features 632 on surface 428 may be segmented versions of alignment features 432 or 532. Similar to alignment features 432 and 532, alignment features 632 may be on surface 428. A group G1 of alignment features 632a and 632c are proximate to side 424, and a group G2 of alignment features 632b and 632d are proximate to side 426. A plurality of optical fibers 112 is between a first group G1 of segmented alignment features 632a, 632c and second group G2 of segmented alignment features 632b, 632d. Alignment features 632a and 632c are longitudinally (y-axis) aligned with each other. Similarly, alignment features 632b and 632d are longitudinally aligned with each other.

Alignment features 632a, 632b, 632c, and 632d extend distances in the longitudinal direction. Alignment features 632a, 632b may have longitudinal lengths of d6, and alignment feature 632c, 632d may have longitudinal lengths of d7. Lengths of d6 and d7 may be the same or different. Alignment features 632a and 632c, and 632b and 632d, are respectively separated by a longitudinal distance d8. The longitudinal distances d8 between alignment features 632a and 632c and between 632b and 632d may be the same, as shown in the figures. In some embodiments, the longitudinal distance d8 between alignment features 632a and 632c may be shorter or longer than the longitudinal distance d8 between alignment features 632b and 632d. The sum of distances d6, d7, and d8 is less than d4, and the distance d4 is less than distance L3, i.e., less than the distance between the first face 420 and second face 422.

Each of the alignment features 632 stands off from a remainder of the surface 428 by a height h1. The height h1 of the alignment features 632 is greater than the diameter of the optical fibers 112.

FIG. 6D is a longitudinal cross-sectional view of a system that includes optical fiber housing 606 and PIC die 608 illustrating an alignment feature 634 on the optical fiber housing interfacing with complementary alignment features 618 on the PIC die, in accordance with some embodiments. FIG. 6D further illustrates an alignment feature 634 on surface 428 of optical fiber housing 606 and a complimentary alignment feature 618 on surface 614 of PIC die 608. Surface 428 is substantially parallel to and faces surface 614. Surface 428 may contact surface 614 in some examples. In other examples, surface 428 may be spaced away from surface 614. The portion of optical fibers 112 within grooves on surface 428 of optical fiber housing 106 are depicted with dashed lines, while portions of optical fibers 112 between surface 428 and surface 614 are depicted with solid lines. Alignment features 634 are depicted with a solid line between surface 428 and surface 614, and with a dashed line below surface 614. Complimentary alignment features 618 are depicted with a dotted line below surface 614. In embodiments, various surfaces of the alignment feature 634 make contact over at least some portion of surfaces of complimentary alignment feature 618. In some embodiments, two or more surfaces of alignment feature 634 contact facing surfaces of complimentary alignment feature 618.

FIG. 6D also illustrates optical elements that may be used to implement a beam expansion technique for coupling light between optical fibers 112 and PIC die waveguides. As illustrated in FIG. 6D, PIC die 108 comprises a plurality of waveguides 615 within the die, which terminate at or on surface 616. The first face 420 of optical fiber housing 406 is substantially parallel to and faces surface 616. In some embodiments, a plurality of first optical elements 636 are at or on first face 420. Each first optical element 636 may be coupled with one or more of the plurality of optical fibers 112. A plurality of second optical elements 638 are at or on surface 616. Each second optical element 638 may be coupled with one or more of the plurality of waveguides 615. In some examples, the first optical elements 636 and second optical elements 638 may be a lens or an array of lenses.

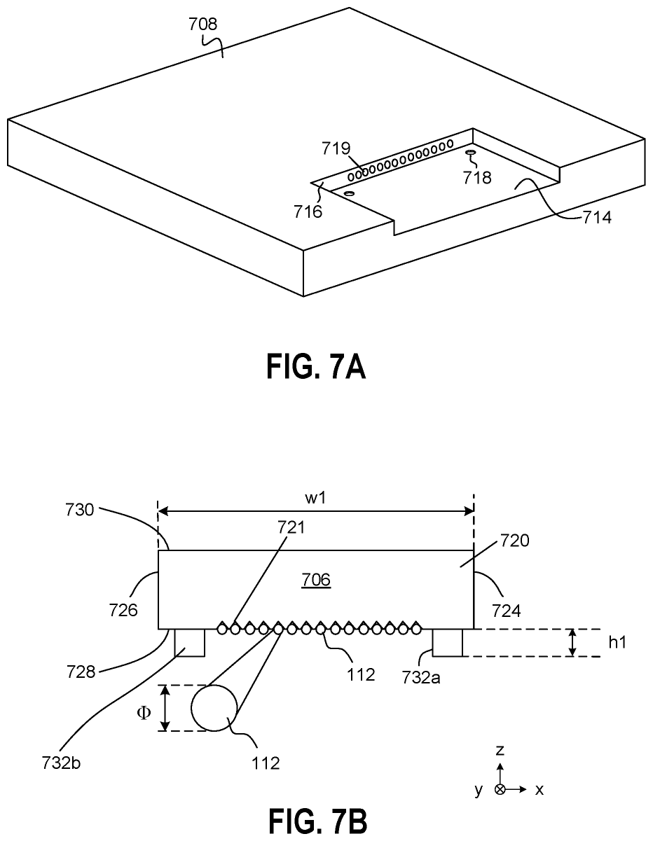

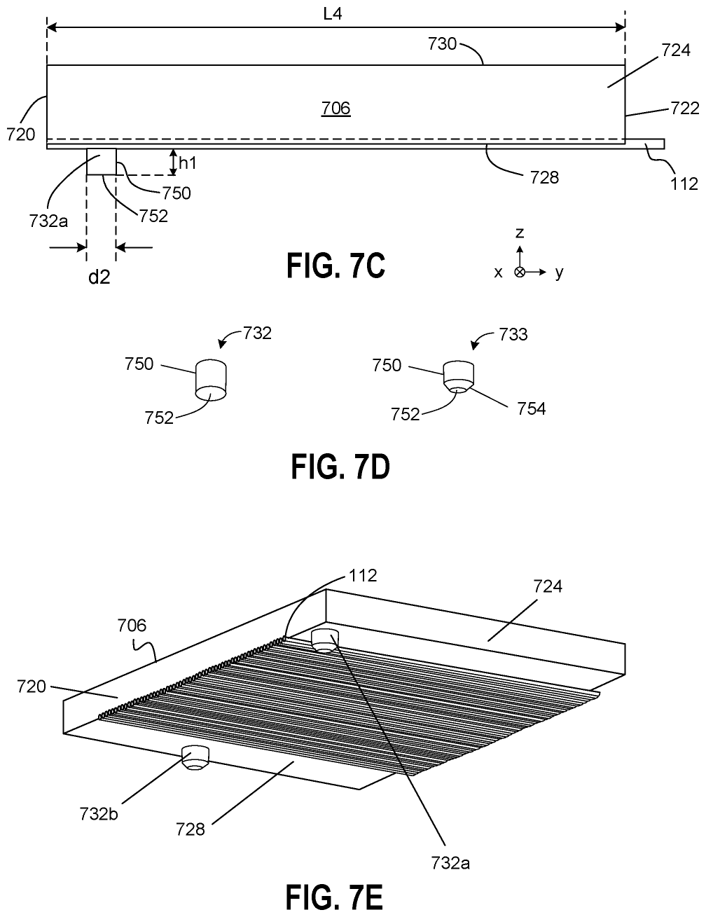

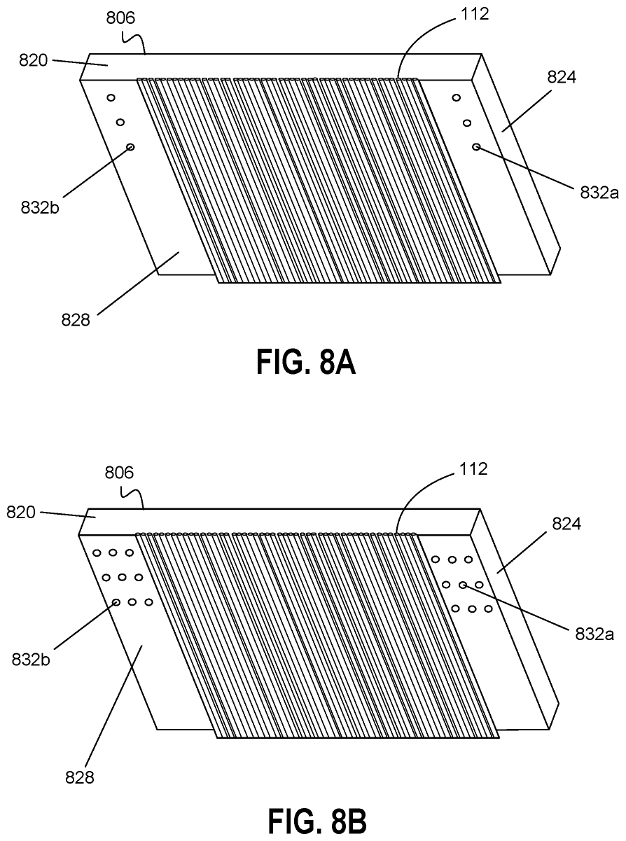

FIG. 7A is an isometric view of a PIC die 708 having a plurality of alignment features, according to some embodiments. PIC die 708 includes a surface 714 and a surface 716. PIC die 708 interfaces with an optical fiber housing 706 at surfaces 714, 716. Surface 716 is substantially orthogonal to surface 714 and includes a plurality of optical waveguide ends 719. The surface 714 includes a plurality alignment features 718, which are complimentary to alignment features 732 on optical fiber housing 706. The alignment features 718 may be blind-holes or openings recessed or indented into surface 714. A wafer level fabrication process may be used to form alignment features 718. For example, an ion milling process that is used to fabricate through-silicon-vias (TSV) may be used to form alignment features 718. The ion milling process can form highly directionally hole features with submicron level tolerance, enabling alignment features 718 to be formed with highly straight side walls. Alignment features 718 may be etched on surface 714 at two sides of the surface outside of the area where optical fibers 112 on a bottom surface of the optical fiber housing 706 may pass.

FIGS. 7B and 7C illustrate side views of an optical fiber housing 706 suitable for coupling high density optical fiber connections with the PIC die 708, in accordance with some embodiments. Optical fiber housing 706 may be similar to optical fiber housings 106 and 206 described above, but with alignment features that are complimentary to alignment features 118 on PIC die 708. FIG. 7D illustrates isometric views of alternative examples of an alignment feature. FIG. 7E is an isometric view of the optical fiber housing 706.

Optical fiber housing 706 includes a first face 720 and a second face 722, which is opposite the first face 720. The first face 720 may be spaced apart from the second face 722 by a first distance L4. Optical fiber housing 106 also includes a first side 724, and a second side 726. First side 724 is opposite second side 726. First side 724 and second side 726 are spaced apart by a transverse width w1. Optical fiber housing 706 includes a surface 728, which is a bottom surface in FIGS. 7B-7C. Surface 728 is orthogonal to the first face 720 and the first side 724. In addition, surface 728 is opposite surface 730, which is a top surface in FIGS. 7B-7C.

Surface 728 includes a plurality of grooves 721 extending in a longitudinal direction between the first face 720 and the second face 722. The grooves 721 may be V-shaped or U-shaped. A plurality of optical fibers 112 extend in the longitudinal direction (in the y direction) between the first face 720 and the second face 722. While optical fiber housing 706 is shown as retaining a relatively small number of optical fibers 112, in some embodiments, optical fiber housing 706 retains a relatively large number of optical fibers 112, e.g., 48. The plurality of optical fibers 112 are laterally spaced apart across a transverse width w1 of the first face 720 (in the x direction) between the first side 724 and the second side 726. Each of the plurality of optical fibers 112 is substantially parallel to surface 728. Each optical fiber 112 comprises a diameter Φ. The plurality of optical fibers 112 are retained in the plurality of grooves 721 on surface 728. The optical fibers 112 may be secured in the grooves with a low CTE epoxy adhesive. In some embodiments, high density optical fibers within an array can be close packed together using cladding diameter for further position control, as cladding diameter tolerance may be less than 1 μm. In some embodiments, optical fiber housing 706 may retain fibers in substantially the same way as optical fiber housing 310 depicted in FIGS. 3A-3C, differing only in the number of optical fibers being retained in the housing, i.e., the plurality of optical fibers 112 are between the first surface and the second surface.

Surface 728 of optical fiber housing 706 includes a plurality of alignment features 732 or 733. In the example shown in FIGS. 7B-7C, alignment feature 732a and alignment feature 732b are on surface 728. FIG. 7D illustrates isometric views of alignment feature 732 and an alternative alignment feature 733 that may be on surface 728. The alignment features 732, 733 may be referred to as “guide pins.” In embodiments, one alignment feature is proximate the first side 724 and another alignment feature is proximate the second side 726. For example, first alignment feature 732a is proximate side 724 and second alignment feature 732b is proximate side 726. The plurality of optical fibers 112 is between the first alignment feature 732a and the second alignment feature 732b. Each of the alignment features 732, 733 is complimentary to an alignment feature 118 on surface 714 of PIC die 708 and stands off from a remainder of the surface 728 by a height h1. In embodiments, alignment features 732, 733 extend away from surface 728 in a vertical or z-dimension direction perpendicular to surface 728. Alignment features or guide pins 732, 733 have sidewalls 750 that are substantially straight and substantially perpendicular to surface 728. In cross section, in an x-y plane, the alignment features 732, 733 may have a cylindrical peripheral surface. An end surface 752 of alignment features 732, 733 may be substantially planar and substantially parallel to surface 728. In some embodiments, e.g., alignment feature 733, sidewalls 750 may include a tapered, chamfered, or beveled portion 754 adjacent or proximate to the surface 752. In some embodiments, the alignment features 732, 733 may be pin or peg shaped. The height h1 of the alignment features 732, 733 is greater than the diameter of the optical fibers 112. In examples in which the alignment features are polymer materials, the alignment features may be made by a high-precision molding process. In examples in which the alignment features are glass, the alignment features may be made by high-precision machining and/or molding.

Optical fiber housing 706 may be placed on surface 714 of PIC die 708 such that the pin-shaped alignment features 732, 733 fall into the hole-type complimentary alignment features 718 on surface 714. In some embodiments, e.g., alignment feature 733, the chamfered or beveled portion on a pin-shaped alignment feature acts serves a lead in function that facilitates assembly. The radius of complimentary alignment features 718 is used to control in-plan alignment accuracy. The depth of hole-type complimentary alignment features 718 and the height h1 of pin-shaped alignment features 732, 733 may be used to precisely control the distance between surface 728 of optical fiber housing 706 and surface 714 of PIC die 708, which in turn controls the alignment between the ends of the optical fiber and the ends of the waveguides.

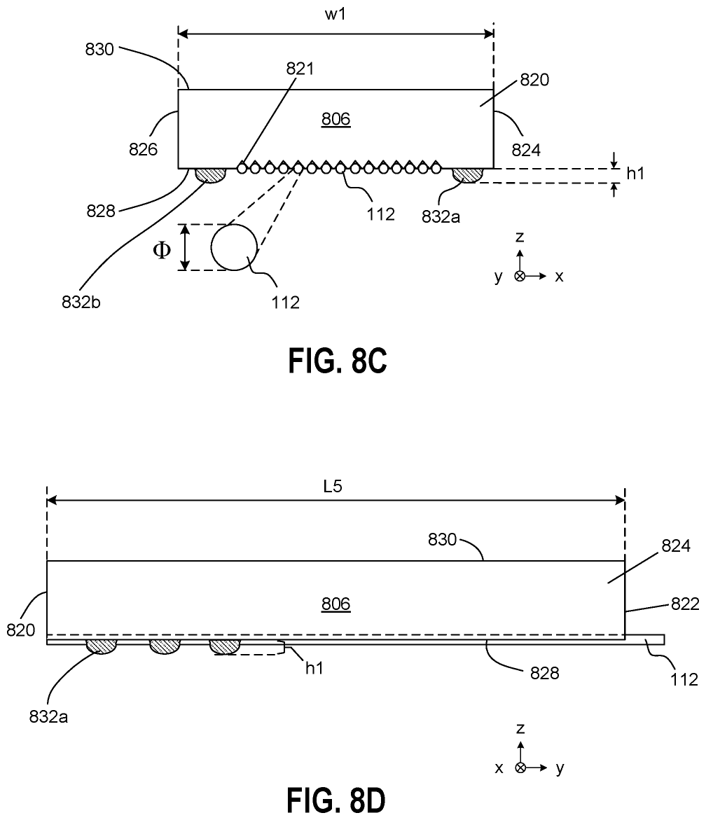

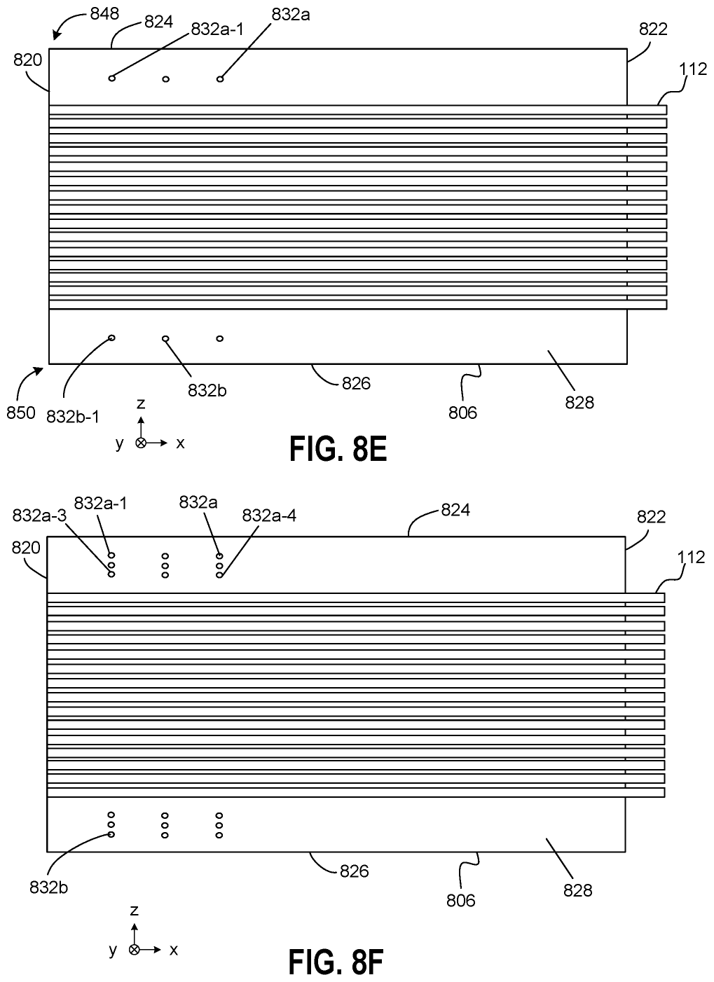

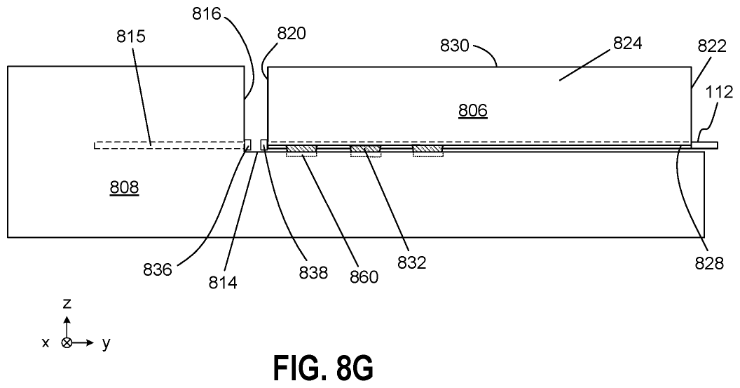

FIGS. 8A-8B are isometric views of an optical fiber housing 806, in accordance with some embodiments. FIGS. 8C-8F illustrate side views of the optical fiber housing 806. FIG. 8G is a longitudinal cross-sectional view of a system that includes optical fiber housing 806 interfacing with a PIC die 808 via alignment features comprising solder, in accordance with some embodiments.

The illustrations of optical fiber housing 806 in FIGS. 8C-8F may be substantially the same as optical fiber housing 806 depicted in FIGS. 8A-8B, differing only in the number of optical fibers being retained in the housing. While optical fiber housing 806 is shown as retaining a relatively small number of optical fibers 112 in FIGS. 8C-8F, in some embodiments, optical fiber housing 806 retains a relatively large number of optical fibers 112, e.g., 48.

Optical fiber housing 806 includes a first face 820 and a second face 822, which is opposite the first face 820. The first face 820 may be spaced apart from the second face 822 by a first distance L5. Optical fiber housing 806 also includes a first side 824, and a second side 826. First side 824 is opposite second side 826. First side 824 and second side 826 are spaced apart by a transverse width w1 (in the x direction). Optical fiber housing 806 includes a surface 828, which is a bottom surface in FIGS. 8C-8G. Surface 828 is orthogonal to the first face 820 and the first side 824. In addition, surface 828 is opposite surface 230.

Surface 828 includes a plurality of grooves 821 extending in the longitudinal direction between the first face 820 and the second face 822. The grooves 821 may be V-shaped or U-shaped. A plurality of optical fibers 112 extend in a longitudinal direction (in the y direction) between the first face 820 and the second face 822. The plurality of optical fibers 112 are laterally spaced apart across a transverse width w1 of the first face 820 between the first side 824 and the second side 826. Each optical fiber 112 comprises a diameter @. Each of the plurality of optical fibers 112 may be substantially parallel to surface 828. The plurality of optical fibers 112 are retained in the plurality of grooves 821 on surface 828. The optical fibers 112 may be secured in the grooves with a low CTE epoxy adhesive. In some embodiments, the optical fibers 112 are within an array. The optical fibers 112 may be closely packed together. The cladding diameter may be used for further position control, as cladding diameter tolerance may be less than 1 μm. The optical fibers 112 may be compatible with temperatures associated with solder reflow processes. In some embodiments, optical fiber housing 806 may retain fibers in substantially the same way as optical fiber housing 310 depicted in FIGS. 3A-3C, i.e., the plurality of optical fibers 112 are between the first surface and the second surface.

In some embodiments, surface 828 of optical fiber housing 806 includes a plurality of alignment features 832 comprising solder. In the example shown in FIGS. 8A-4G, solder alignment features 832a and 832b are on surface 828. In some embodiments, the first solder alignment features 832a are proximate the first side 824 and second solder alignment features 832b are proximate the second side 826. The plurality of optical fibers 112 is between the first solder alignment features 832a and the second solder alignment features 832b. Each of the solder alignment features 832 may comprise any suitable solder alloy, such as Sn alloys (e.g., SAC). In some embodiments, solder alignment features 832 may be a combination of metal pad and a solder ball. For example, in embodiments in which optical fiber housing 806 comprises glass, metal pads may be formed by a thin film deposition process or a selective plating process on optical fiber housing 806, and solder balls may be attached to the metal pads. Each of the solder alignment features 832 stands off from a remainder of the surface 828 by a height h1. The height h1 of the alignment features 832 is greater than the diameter of the optical fibers 112.

In some embodiments, the solder alignment features 832a are substantially aligned with one another along a line parallel first side 824 in the longitudinal direction between the first face 820 and the second face 822. Longitudinally aligned solder features may be referred to as a set of solder features. In FIG. 8E, solder alignment features 832a and 832a-1 are included in a first set of solder features. As can be seen in FIG. 8E, solder alignment feature 832a-1 is proximate to a corner 848 where first side 824 and first face 820 meet. Being proximate to a corner 848, solder alignment feature 832a-1 is proximate both first side 824 and first face 820. A second set of solder features is between second side 826 and optical fibers 112, and includes solder alignment features 832b and 832b-1. Solder alignment feature 832b-1 is proximate to a corner 850 where second side 826 and first face 820 meet.

Referring to FIG. 8F, the first solder features may comprise two or more sets of longitudinally aligned solder features. Each set includes a longitudinal row of two or more solder features. Each solder feature in a set is the same distance from side 824. In an example, a first set of solder features includes solder alignment features 832a and 832a-1. A second set of solder features includes solder alignment features 832a-3 and 832a-4. Both of the first and second sets of longitudinally aligned solder features are between the first side 824 and the plurality of optical fibers 112. However, each first solder feature in the first set is a first distance from the first side, and each first solder feature in the second set is a second distance from the first side. The first and second distances are different. In FIG. 8F, the second set of solder alignment features are further from side 824 than first set of solder features.

FIG. 8G is a longitudinal cross-sectional view of a system that includes optical fiber housing 806 and a PIC die 808, in accordance with some embodiments. FIG. 8G further illustrates a solder alignment feature 832 on surface 828 of optical fiber housing 806. Surface 828 is substantially parallel to and faces surface 814. The first face 820 of optical fiber housing 806 is substantially parallel to a surface 816 of the PIC die. The portion of optical fibers 112 within grooves on surface 828 of optical fiber housing 806 are depicted with dashed lines, while portions of optical fibers 112 between surface 828 and surface 814 are depicted with solid lines. The plurality of first solder alignment features 832a and the plurality of second alignment solder features 832b interface with complementary metal features 860 on the PIC die 808.

FIG. 8G also illustrates optical elements that may be used to implement a beam expansion technique for coupling light between optical fibers 112 and PIC die waveguides. As illustrated in FIG. 8G, PIC die 808 comprises a plurality of waveguides 815 within the die, which terminate at or on surface 816. The first face 420 of optical fiber housing 406 is substantially parallel to and faces surface 816. In some embodiments, a plurality of first optical elements 838 are at or on first face 820. Each first optical element 438 may be coupled with one or more of the plurality of optical fibers 112. A plurality of second optical elements 836 are at or on surface 816. Each second optical element 836 may be coupled with one or more of the plurality of waveguides 815. In some examples, the first optical elements 836 and second optical elements 838 may be a lens or an array of lenses.

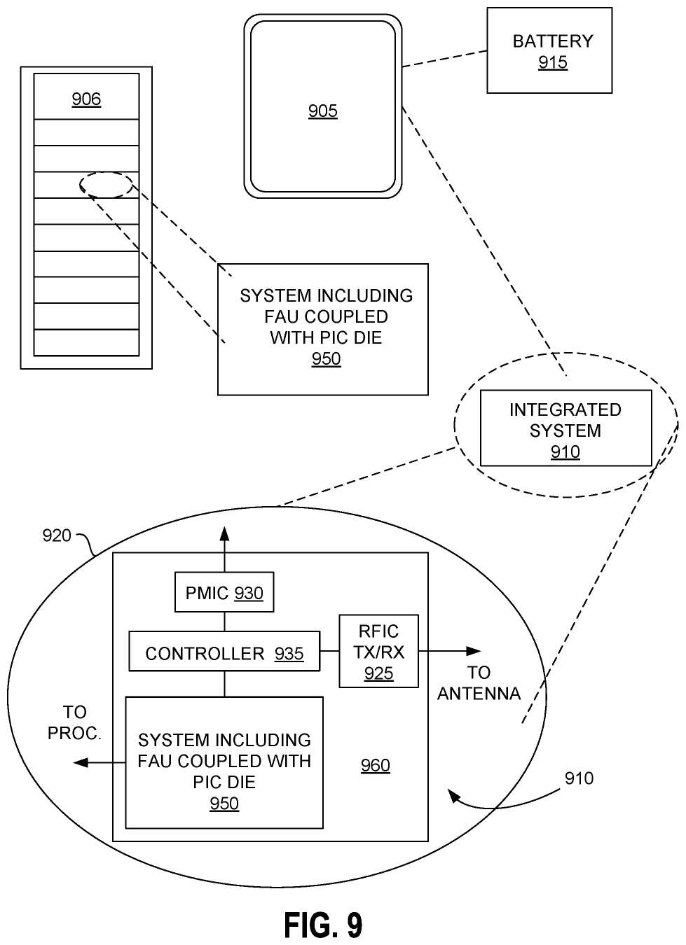

FIG. 9 illustrates a mobile computing platform and a data server machine employing one or more apparatus comprising an optical fiber housing comprising alignment features on a surface of housing that interface with complimentary alignment features on a surface of a PIC die, for example as described elsewhere herein. For example, mobile computing platform 905 or server machine 906 may include an optical fiber housing coupled with a PIC die as described elsewhere herein. Server machine 906 may be any commercial server, for example including any number of high-performance computing platforms disposed within a rack and networked together for electronic data processing. The mobile computing platform 905 may be any portable device configured for each of electronic data display, electronic data processing, wireless electronic data transmission, or the like. For example, the mobile computing platform 905 may be any of a tablet, a smart phone, laptop computer, etc., and may include a display screen (e.g., a capacitive, inductive, resistive, or optical touchscreen), a chip-level or package-level integrated system 910, and a battery 915.

Whether disposed within the integrated system 910 illustrated in the expanded view 920, or as a stand-alone package within the server machine 906, the integrated system or server machine includes an apparatus comprising an optical fiber housing comprising alignment features on a surface of housing that interface with complimentary alignment features on a surface of a PIC die, as described elsewhere herein. System 950 may be further coupled to a host substrate 960, along with, one or more of a power management integrated circuit (PMIC) 930, RF (wireless) integrated circuit (RFIC) 925 including a wideband RF (wireless) transmitter and/or receiver (TX/RX) (e.g., including a digital baseband and an analog front-end module further comprises a power amplifier on a transmit path and a low noise amplifier on a receive path), and a controller 935. PMIC 930 may perform battery power regulation, DC-to-DC conversion, etc., and so has an input coupled to battery 915 and with an output providing a current supply to other functional modules. As further illustrated, in the exemplary embodiment, RFIC 925 has an output coupled to an antenna (not shown) to implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 4G, and beyond.

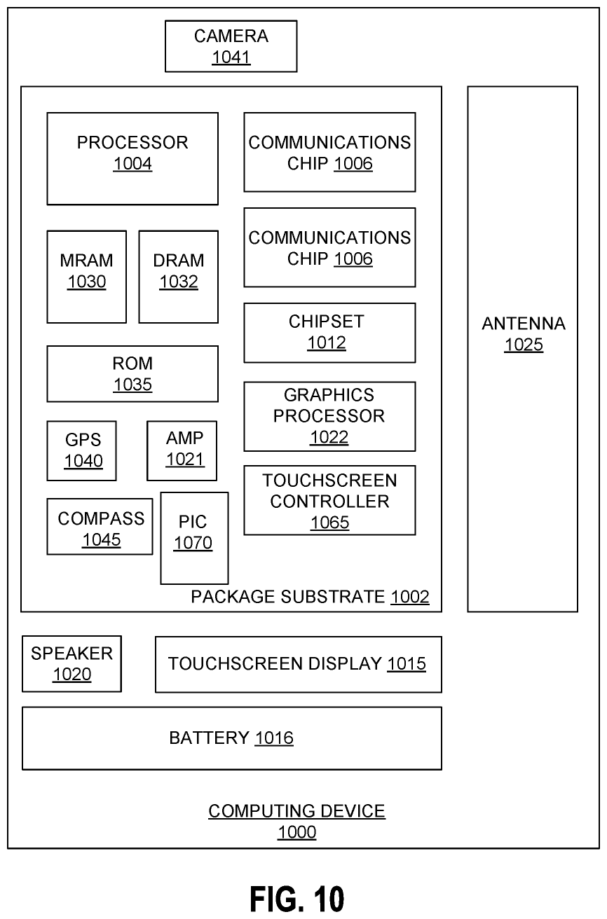

FIG. 10 is a functional block diagram of an electronic computing device 1000, in accordance with an embodiment of the present invention. The computing device may be found inside mobile computing platform 905 or server machine 906, as described elsewhere herein. Device 1000 further includes a package substrate 1002 hosting a number of components, such as, but not limited to, PIC die 1070 and a processor 1004 (e.g., an applications processor). Processor 1004 may be physically and/or electrically coupled to package substrate 1002. In general, the term “processor” or “microprocessor” may refer to any device or portion of a device that processes electronic data from registers and/or memory to transform that electronic data into other electronic data that may be further stored in registers and/or memory. In some examples, one or more of the components of computing device 1000 includes an optical fiber housing comprising alignment features on a surface of housing that interface with complimentary alignment features on a surface of a PIC die, as described elsewhere herein.

In various examples, one or more communication chips 1006 may also be physically and/or electrically coupled to the package substrate 1002. In further implementations, communication chips 1006 may be part of processor 1004. Depending on its applications, computing device 1000 may include other components that may or may not be physically and electrically coupled to package substrate 1002. These other components include, but are not limited to, volatile memory (e.g., DRAM 1032), non-volatile memory (e.g., ROM 1035), flash memory (e.g., NAND or NOR), magnetic memory (MRAM 1030), a graphics processor 1022, a digital signal processor, a crypto processor, a chipset 1012, an antenna 1025, touchscreen display 1015, touchscreen controller 1065, battery 1016, audio codec, video codec, power amplifier 1021, global positioning system (GPS) device 1040, compass 1045, accelerometer, gyroscope, speaker 1020, camera 1041, and mass storage device (such as hard disk drive, solid-state drive (SSD), compact disk (CD), digital versatile disk (DVD), and so forth), or the like.

Communication chips 1006 may enable wireless communications for the transfer of data to and from the computing device 1000. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. Communication chip 1006 may implement any of a number of wireless standards or protocols. As discussed, computing device 1000 may include a plurality of communication chips 1006. For example, a first communication chip may be dedicated to shorter-range wireless communications, such as Wi-Fi and Bluetooth, and a second communication chip may be dedicated to longer-range wireless communications such as GPS, EDGE, GPRS, CDMA, WiMAX, LTE, Ev-DO, and others.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

It will be recognized that the invention is not limited to the embodiments so described, but can be practiced with modification and alteration without departing from the scope of the appended claims. For example, the above embodiments may include specific combinations of features as further provided below.

Example 1: A device, comprising: a first face, a second face opposite the first face, a first side, and a second side opposite the first side, wherein the first face is spaced apart from the second face by a first distance; a plurality of optical fibers extending in a longitudinal direction between the first face and the second face, and laterally spaced apart across a transverse width of the first face between the first side and the second side, wherein each optical fiber comprises a diameter; and a plurality of features on a surface of the device orthogonal to the first face and the first side, wherein each feature stands off from a remainder of the surface by a height greater than the diameter, extends a second distance in the longitudinal direction that is less than the first distance, and comprises a curved or V-shaped peripheral surface.

Example 2: The device of claim 1, wherein: a first feature is proximate the first side and a second feature is proximate the second side; and the plurality of optical fibers is between the first feature and the second feature.

Example 3: The device of claim 2, further comprising a third feature proximate the first side and a fourth feature proximate the second side, wherein the third feature is longitudinally aligned with the first feature, and the fourth feature is longitudinally aligned with the second feature.

Example 4: The device of claim 1, wherein the height comprises a first height and a second height, a first feature comprises a first longitudinal section comprising the first height and a second longitudinal section comprising the second height, wherein the first and second height are different.

Example 5: The device of claim 1, wherein the surface comprises a plurality of grooves extending in the longitudinal direction between the first face and the second face, and the plurality of optical fibers are in the plurality of grooves.

Example 6: The device of claim 1, wherein the surface is a first surface, further comprising a second surface opposite the first surface, and the plurality of optical fibers are between the first and the second surface.

Example 7: The device of claim 1, wherein the first face further comprises a plurality of optical elements and each optical element is coupled with one of the plurality of optical fibers.

Example 8: The device of claim 7, wherein the surface is a first surface, and: the first surface is substantially parallel to a second surface of a photonic integrated circuit (PIC) die, and the first face is substantially parallel to a third surface of the PIC die, when the plurality of features is to interface with complementary features on the second surface of the PIC die; and the PIC die comprises a plurality of planar optical waveguides, each optical waveguide terminating at the third surface of the PIC die.

Example 9: The device of claim 1, wherein the features comprise alignment features.

Example 10: A device, comprising: a first face, a second face opposite the first face, a first side, and a second side opposite the first side; a plurality of optical fibers extending in a longitudinal direction between the first face and the second face, and laterally spaced apart across a transverse width of the first face between the first side and the second side, wherein each optical fiber is substantially parallel to a surface of the housing orthogonal to the first face and the first side; and a plurality of guide pins on the surface, wherein each guide pin stands off from a remainder of the surface and comprises a sidewall perpendicular to the surface.

Example 11: The device of claim 10, further comprising: wherein a first guide pin is proximate the first side and a second guide pin is proximate the second side; and wherein the plurality of optical fibers is between the first guide pin and the second guide pin.

Example 12: The device of claim 10, wherein at least one of the guide pins is cylindrical and comprises a beveled surface proximate an end surface.

Example 13: The device of claim 10, wherein the surface comprises a plurality of grooves extending in the longitudinal direction between the first face and the second face, and the plurality of optical fibers are in the plurality of grooves.

Example 14: The device of claim 10, wherein the surface is a first surface, further comprising a second surface opposite the first surface, and the plurality of optical fibers are between the first surface and the second surface.

Example 15: The device of claim 10, wherein: the first face further comprises an optical element coupled with each of the plurality of optical fibers.

the surface is a first surface and is substantially parallel to a second surface of a photonic integrated circuit (PIC) die, and the first face is substantially parallel to a third surface of the PIC die when the plurality of guide pins is to interface with complementary guide holes on the PIC die; and the PIC die comprises a plurality of optical waveguides, each optical waveguide terminating at the third surface of the PIC die.

Example 16: A device, comprising: a plurality of optical fibers extending longitudinally between a first face and a second face of the device, wherein each optical fiber is substantially parallel to a surface of the device; a first side orthogonal to both the first face and the surface, and a second side opposite the first side; a plurality of first solder features on the surface proximate the first side, and a plurality of second solder features on the surface proximate the second side; and wherein the plurality of optical fibers is between the first solder features and the second solder features.

Example 17: The device of claim 16, wherein each first solder feature is longitudinally aligned with other first solder features, and one of the first solder features is proximate the first face.

Example 18: The device of claim 16, wherein the first solder features comprise a first set of longitudinally aligned solder features and a second set of longitudinally aligned solder features, each first solder feature in the first set is a first distance from the first side, each first solder feature in the second set is a second distance from the first side, and the first and second distances are different.

Example 19: The device of claim 16, wherein the surface comprises a plurality of grooves extending between the first face and the second face, and the plurality of optical fibers is in the plurality of grooves.

Example 20: The device of claim 16, wherein: the first face further comprises an optical element coupled with each of the plurality of optical fibers; the surface is a first surface, the first surface is substantially parallel to a second surface of a photonic integrated circuit (PIC) die, and the first face is substantially parallel to a third surface of the PIC die, when the plurality of first solder features and the plurality of second solder features is to interface with complementary metal features on the PIC die; and the PIC die comprises a plurality of optical waveguides, each optical waveguide terminating at the third surface of the PIC die.

The foregoing description is intended to be illustrative and not limiting. Variations will occur to those skilled in the art. Those variations are intended to be included in various embodiments, which are limited only by the scope of the claims that follow.

What is claimed is:

1. A device, comprising:
a first face, a second face opposite the first face, a first side, and a second side opposite the first side, wherein the first face is spaced apart from the second face by a first distance;
a plurality of optical fibers extending in a longitudinal direction between the first face and the second face, and laterally spaced apart across a transverse width of the first face between the first side and the second side, wherein each optical fiber comprises a diameter; and
a plurality of features on a surface of the device orthogonal to the first face and the first side, wherein each feature stands off from a remainder of the surface by a height greater than the diameter, extends a second distance in the longitudinal direction that is less than the first distance, and comprises a curved or V-shaped peripheral surface.

2. The device of claim 1, wherein:
a first feature is proximate the first side and a second feature is proximate the second side; and
the plurality of optical fibers is between the first feature and the second feature.

3. The device of claim 2, further comprising a third feature proximate the first side and a fourth feature proximate the second side, wherein the third feature is longitudinally aligned with the first feature, and the fourth feature is longitudinally aligned with the second feature.

4. The device of claim 1, wherein the height comprises a first height and a second height, a first feature comprises a first longitudinal section comprising the first height and a second longitudinal section comprising the second height, wherein the first and second height are different.

5. The device of claim 1, wherein the surface comprises a plurality of grooves extending in the longitudinal direction between the first face and the second face, and the plurality of optical fibers are in the plurality of grooves.

6. The device of claim 1, wherein the surface is a first surface, further comprising a second surface opposite the first surface, and the plurality of optical fibers are between the first and the second surface.

7. The device of claim 1, wherein the first face further comprises a plurality of optical elements and each optical element is coupled with one of the plurality of optical fibers.

8. The device of claim 7, wherein the surface is a first surface, and:
the first surface is substantially parallel to a second surface of a photonic integrated circuit (PIC) die, and the first face is substantially parallel to a third surface of the PIC die, when the plurality of features is to interface with complementary features on the second surface of the PIC die; and
the PIC die comprises a plurality of planar optical waveguides, each optical waveguide terminating at the third surface of the PIC die.

9. The device of claim 1, wherein the features comprise alignment features.

10. A device, comprising:
a first face, a second face opposite the first face, a first side, and a second side opposite the first side;
a plurality of optical fibers extending in a longitudinal direction between the first face and the second face, and laterally spaced apart across a transverse width of the first face between the first side and the second side, wherein each optical fiber is substantially parallel to a surface of the housing orthogonal to the first face and the first side; and
a plurality of guide pins on the surface, wherein each guide pin stands off from a remainder of the surface and comprises a sidewall perpendicular to the surface.

11. The device of claim 10, further comprising:
wherein a first guide pin is proximate the first side and a second guide pin is proximate the second side; and
wherein the plurality of optical fibers is between the first guide pin and the second guide pin.

12. The device of claim 10, wherein at least one of the guide pins is cylindrical and comprises a beveled surface proximate an end surface.

13. The device of claim 10, wherein the surface comprises a plurality of grooves extending in the longitudinal direction between the first face and the second face, and the plurality of optical fibers are in the plurality of grooves.

14. The device of claim 10, wherein the surface is a first surface, further comprising a second surface opposite the first surface, and the plurality of optical fibers are between the first surface and the second surface.

15. The device of claim 10, wherein:
the first face further comprises an optical element coupled with each of the plurality of optical fibers;
the surface is a first surface and is substantially parallel to a second surface of a photonic integrated circuit (PIC) die, and the first face is substantially parallel to a third surface of the PIC die when the plurality of guide pins is to interface with complementary guide holes on the PIC die; and
the PIC die comprises a plurality of optical waveguides, each optical waveguide terminating at the third surface of the PIC die.

16. A device, comprising:
a plurality of optical fibers extending longitudinally between a first face and a second face of the device, wherein each optical fiber is substantially parallel to a surface of the device;
a first side orthogonal to both the first face and the surface, and a second side opposite the first side;
a plurality of first solder features on the surface proximate the first side, and a plurality of second solder features on the surface proximate the second side; and
wherein the plurality of optical fibers is between the first solder features and the second solder features.

17. The device of claim 16, wherein each first solder feature is longitudinally aligned with other first solder features, and one of the first solder features is proximate the first face.

18. The device of claim 16, wherein the first solder features comprise a first set of longitudinally aligned solder features and a second set of longitudinally aligned solder features, each first solder feature in the first set is a first distance from the first side, each first solder feature in the second set is a second distance from the first side, and the first and second distances are different.

19. The device of claim 16, wherein the surface comprises a plurality of grooves extending between the first face and the second face, and the plurality of optical fibers is in the plurality of grooves.

20. The device of claim 16, wherein:
the first face further comprises an optical element coupled with each of the plurality of optical fibers;
the surface is a first surface, the first surface is substantially parallel to a second surface of a photonic integrated circuit (PIC) die, and the first face is substantially parallel to a third surface of the PIC die, when the plurality of first solder features and the plurality of second solder features is to interface with complementary metal features on the PIC die; and
the PIC die comprises a plurality of optical waveguides, each optical waveguide terminating at the third surface of the PIC die.
